(19) United States
(12) Patent Application Publication
(10) Pub. No.: US 2016/0132771 A1
(43) Pub. Date: May 12, 2016

(54) Application Complexity Computation

(71) Applicant: Google Inc., Mountain View, CA (US)

(72) Inventors: Sanketh Shetty, Sunnyvale, CA (US); Ibrahim Elbouchikhi, San Francisco, CA (US)

(21) Appl. No.: 14/539,392

(22) Filed: Nov. 12, 2014

(51) Int. Cl. G06N 5/02; H04L 29/08; G06N 99/00; H04W 4/00; G06Q 30/06

(52) U.S. Cl. CPC G06N 5/02; H04W 4/003; G06Q 30/0631; G06N 99/005; H04L 67/32

(57) ABSTRACT

A machine learning technique may be applied to applications hosted by an application store to extract features that can be utilized to train one or more classifiers of the applications based on their relative complexity. A processor may receive pairwise comparisons of relative complexity and feature representations for the applications to be used in training of a classifier. The processor may determine a feature set that is correlated with the pairwise comparison of relative complexity and obtain a classifier based thereupon.

### BACKGROUND

Many application stores provide an indication of a user rating, a download amount, or similar metric for a given application. In some cases, the application store may generate a recommendation to a particular user for one or more applications based on the user's purchase history, the user's browsing history, the user's friends' purchases, downloads, ratings of applications, etc. However, it may be difficult for a user to ascertain how one application compares to another application. For example, if the application is a video game, a user may be interested in knowing how easy or difficult the game is.

### BRIEF SUMMARY

According to an implementation, a processor may receive pairwise comparisons of relatively complexity for applications hosted by an application store. Features for the applications may be obtained such as a visual density of an image, a frequency of scene changes in a video, an average length of failed gameplay, a rating, a download number, and a sentiment metric. The processor may obtain a classifier by determining a feature set that includes a portion of the features that correlate with the pairwise comparisons of relative complexity for the applications.

In an implementation, a system is disclosed that includes a database and a processor communicatively coupled thereto. The database may store pairwise comparisons of relative complexity for each application as compared to other applications. Each of the applications may be hosted by an application store server. The processor may be configured to receive the pairwise comparisons of relative complexity from the database. It may obtain features for the applications such as a visual density of an image, a frequency of scene changes in a video, an average length of failed gameplay, a rating, a download number, and a sentiment metric. The processor may obtain a classifier by determining a feature set that includes a portion of the plurality of features that are correlated with the pairwise comparison of relative complexity for the applications.

In an implementation, a system according to the presently disclosed subject matter includes a database and a processor. The database may have a means for storing pairwise comparisons of relative complexity for each application hosted by an application store as compared to other applications hosted by the application store. The system may include a processor communicatively coupled to the database. The system may include a means for receiving pairwise comparisons of relatively complexity for applications hosted by an application store. The system may include a means for obtaining features for the applications. The features may be, for example, a visual density of an image, a frequency of scene changes in a video, an average length of failed gameplay, a rating, a download number, and a sentiment metric. The system may include a means for obtaining a classifier by determining a feature set that includes a portion of the features that correlate with the pairwise comparisons of relative complexity for the applications.

Implementations disclosed herein may allow for the automatic determination of the relative complexity of an application in comparison to one or more other applications, and may allow for user-specific recommendations based upon an appropriate or desired level of complexity. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process for obtaining a classifier and applying the obtained classifier to an application as disclosed herein.

FIG. 2 is an example of system that may be configured to obtain a classifier based on pairwise comparison data and feature representations of applications stored in a database as disclosed herein.

FIG. 3 shows a computer according to an implementation of the disclosed subject matter.

FIG. 4 shows a network configuration according to an implementation of the disclosed subject matter.

### DETAILED DESCRIPTION

Implementations disclosed herein utilize machine learning techniques to generate an indication of complexity of an application relative to other applications, generally or of a similar category. Moreover, the complexity indication can be personalized based on different users utilizing a user's expertise, demographic information, or other information specific to the user. The complexity of an application may refer to the amount or degree of interaction among the various features that make up the user interface component of an application. For example, the user interface of an email application may have a few simple menus, a relatively uniform color scheme, and a few icons through which a user may access the various simple menus. The level of organization, number of interactive objects, and color usage for this particular application may be associated with a simplistic or less complex application as compared to one that has many menus, widely varied colors, and many options. Other features that are not associated with a user interface may also provide insight into complexity. For example, if users are constantly accessing help menus or making requests about where to locate a specific function or item or how to perform specific functions, then the application might be relatively complex. In video games, for example, a number of key strokes or touch inputs may be correlated with complexity in combination with a length of gameplay and completion rate (e.g., the number of attempts before successful completion of a mission or board). Complexity may have slightly different meanings in different contexts such as the examples provided above with respect to an email application and a video game. The features determined to be associated with complexity, therefore, may differ depending on the context (e.g., category of application). Thus, in general, the complexity of an application may provide a relative indication of how complex the application is from a user perspective, in comparison to other applications of a similar type.

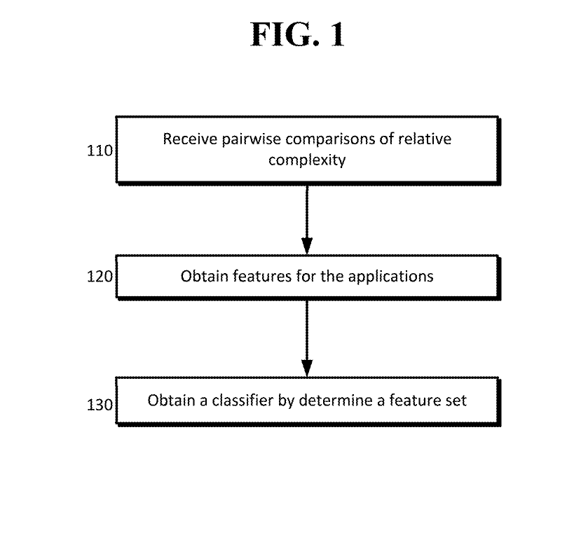

According to an implementation, an example of which is provided in FIG. 1, a processor may receive pairwise comparisons of relative complexity for several applications at 110. The processor may be a part of an application store server, for example. Similarly, the applications may be hosted by an application store. An application store may refer to a collection of servers or server farms that deliver a variety of content to end users including, but not limited to, an application, a movie, a song, and an electronic book. The application store may be accessible by a mobile device such as a smartphone or tablet as well as conventional computer systems such as a laptop or desktop computer. A client device may interface with the application store server by launching an application on a client device. For example, the client device may utilize a web browser or a stand-along application to interface with the application store. With a user's permission, the application store may receive signals from the client device that indicate a user's identity, a user's browsing history, etc. Similarly, a user's activity or use of services provided by the application store may be stored in a database connected to the application store. For example, a user's purchase history, application download or installation history, comment history, ratings history, browsing history (e.g., applications a user has viewed), other prior actions, or the like may be stored in a database and associated with the particular user. The application store may generate a recommendation for a user based on any of the aforementioned features. For example, a user who frequently views and downloads a particular category of video game applications may receive a recommendation for a game that the user has not installed and that is rated highly by the user's peers (e.g., demographically similar users or friends of the user).

A pairwise comparison for complexity may be received by the processor and, for example, stored in the database. In some implementations, a human who is trained to rate and/or compare two applications, may judge one application to be more complex than another. The human rater may be shown an example screenshot for each application and indicate which of the two applications appears to be more complex. In some instances, a human rater may use both applications and submit a judgment regarding complexity as between the two applications after using each application for a period of time. For example, the user may play two video games or attempt to complete a level on each video game application.

The pairwise comparison from the human rater or a computationally-determined complexity may be stored in the database in the form of a table or otherwise. For example, Table 1 below shows the result of a pairwise comparison for four applications, A, B, C, and D.

TABLE 1

| | A | B | C | D | Sum |
|---|---|---|---|---|---|
| A | — | 1 | 1 | 1 | 3 |
| B | 0 | — | 1 | 1 | 2 |
| C | 0 | 0 | — | 1 | 1 |
| D | 0 | 0 | 0 | — | 0 |

In Table 1, a value of “1” indicates that in a comparison, such as application A compared to application B, that the first application is more complex. A “0” indicates the opposite. The sum of the results can be utilized as an overall indicator of the applications complexity relative to other applications. In the example shown in Table 1, application A is rated as more complex in each comparison (e.g., to B, C, and D). Based on the pairwise comparisons shown in Table 1, the applications can be ranked in order of most complex to least complex as follows: A, B, C, and D. The human judgment of complexity is an active method for obtaining pairwise comparisons of applications on the application store. In some implementations, a passive method may be utilized to obtain the pairwise comparisons. Demographic data (e.g., age, gender, location, etc.) may be dissected and associated with complexity. For example, video games that teenagers play for longer periods of time may be inferred to be less complex than those video games they play for shorter periods of time. The inference regarding length of play and age of a given user may be established as a rule and applied by the processor. Length of gameplay or application use may be a signal that is received by the application store. As another example, a feature such as a texture analysis of screenshots (e.g., histogram of gradients) or object analysis of screenshots from different applications may indicate that one application is more complex than another one. For example, the system may determine that an application with a higher number of gradients, more user interfaces, a greater range of types of interfaces, or the like has a higher complexity than one with fewer gradients, interfaces, or types of interfaces. Thus, a passive method may utilize features that can be extracted from the data associated with an application (e.g., images, videos, ratings, comments, description, length of play, etc.) and/or users (e.g., demographic information) as a proxy for the human rating. The data stored in the database using a passive method may be similar to the example provided in Table 1. That is, an object detection performed on screenshots from two images may show application A is more complex than application B. Thus, the pairwise comparison of application A to application B would be 1. Conversely, the pairwise comparison of application B to application A would receive a score of 0. For the purposes of a machine learning technique as disclosed herein, if a feature is utilized to perform pairwise comparisons, then the feature may be eliminated from the feature set available for the training of a classifier by a machine learning technique to prevent over-reliance on the same feature by the trained classifier.

The pairwise comparisons may be utilized to select a training set of applications as an input for a machine learning technique. The examples contained herein are in the context of a supervised learning form in which the system is provided inputs that are deemed to be of a particular category (e.g., complex or not complex). The system may extract features of the training set of applications that are associated with being more complex or simplistic based on the inputs provided. For example, one training set may include applications that are deemed to be complex based on the pairwise comparisons and another training set may include those applications deemed to be simplistic based on the pairwise comparisons.

In some configurations, applications present on the application store may be represented by a variety of features. A non-exhaustive list of features includes: a visual density of an image, a frequency of scene changes in a video, an average length of failed gameplay, a rating, a download number, and a sentiment metric. A visual density or texture analysis of an image may be performed using an edge detection technique, a histogram of gradients, etc. The system may utilize images that are uploaded to the application store server or that are associated with the application on other websites (e.g., the developer's web page for the application). Similarly, a video may be uploaded to the application store as promotional material and/or obtained from sources external to the application store such as a video aggregation website to which users can upload videos. Individual frames from a video may be analyzed similarly to an image. An average length of failed gameplay may refer to the amount of time a game is played until an objective is achieved. More generally, an application use time may be represented as the amount of time used per session. A session may refer to the time from when an application is launched on a client device (e.g., smartphone, tablet, laptop, etc.) until the application is closed. The application, when closed, may still exist in temporary memory space. Other metrics based on time and use for an application may be utilized. For example, the number of times a game is played before an objective is achieved may be represented. An amount of time to complete a game or a board, for which a board may contain multiple objectives, may be represented.

As stated earlier, users of the application store may provide a rating and/or comment regarding a particular application. The comments and/or reviews from external sources may be a source of sentiment analysis. In some configurations, a word analysis of comments and/or reviews associated with the game may be performed. The system may be configured with sets of keywords to search and tally the number of occurrences of words in a given set for the comments and/or reviews to ascertain the sentiment regarding a particular application. For example, one set may be considered a “good” set and include the words good, great, best, amazing. Another set may be considered a “bad” set and include the words bad, awful, horrible, substandard. A sentiment analysis may compute the number of instances of each word to determine an overall sentiment. For example, the “good” words may appear 314,159 while the “bad” words may occur 60,221 times in the same source material. The sentiment may be represented as the ratio of the “good” word instances compared to the “bad” word instances, or approximately 5 in this case. The sentiment may indicate an overall positive sentiment for the application in this example. A more complex form of sentiment analysis may incorporate more word sets to indicate varied sentiments and/or other forms of sentiment such as an application rating.

Features may be obtained for applications to be considered in the training set as well as other applications hosted by the application store at 120. Features may be computed and updated periodically. The feature representations may be stored in a database. Some of the features may not be computed upon upload of an application to the application store. For example, a number of downloads of an application is expected to be relatively small initially. Such features, therefore, may be excluded from the features until they are mature. In the example of downloads, it may not be incorporated in the features or utilized to influence complexity computations until a certain number of downloads have occurred and/or the passage of a threshold amount of time.

A training set of applications may be selected under a supervised machine learning approach and used to train a classifier. The training set of applications may be selected because the features that represent it are well defined within the applications in the set. In general, the greater the number of applications for which a feature value is known, the better defined the feature is within the set of applications. Similarly, the more data available for a specific feature for an application, the better defined that feature is with respect to that application. For example, an application with relatively well-defined features may have a relatively large number of downloads, have been available for a relatively long period of time (e.g., more than 6 months), have a relatively large installation base, and an abundance of source material (e.g., user ratings, user comments, reviews, videos, images, etc.) from which features may be extracted. The training set of applications may be a fraction of the total applications for which features are available. Typically in a machine learning approach, a portion of the training set is not used in training the classifier, and the analysis may be repeated. In some configurations, depending on the training set size, cross validation using a portion of the training set may be performed.

Returning to FIG. 1, the processor, at 130, may obtain a classifier by determining that a subset of the features (e.g., a feature set) is correlated with the pairwise comparison of relative complexity for the applications in the training set that have been selected as being complex. For example, a variety of machine learning techniques may be employed with any of the implementations disclosed herein such as k-nearest neighbors, linear regression, logistic regression, or support vector machine. The result of applying the supervised machine learning technique to the training set of application is that a classifier may be obtained based on the feature set. For example, a training set for first person shooter applications that are deemed complex based on pairwise comparisons may indicate that a large number of objects, a high average gameplay, and a relatively high number of users below the age of 30 is positively correlated with complexity. Other features may be negatively correlated with complexity for this particular category of applications. The feature set, therefore, may define a classifier that utilizes the features contained in the feature set as a basis for determining the relative complexity of first person shooter applications, in this example. A different category of applications may have a different feature set that defines relative complexity for that category.

Once the classifier has been trained on the training set and possibly validated, the classifier may be applied to new applications uploaded to the application store and/or applications that were not a part of the training set. For example, a newly uploaded application may contain screenshots and/or a video. The classifier may be applied to this source material to characterize the application to generate a complexity score. The complexity score may be presented to client devices that access (e.g., view) the specific application on the application store.

When applied to an application, the classifier may result in a complexity score being generated for the application. For example, features A, B, and C may be determined to be sufficient to classify the complexity of role-playing games (“RPG”). Feature A may be a download number. The classifier may determine that a download number in excess of 100,000 is positively correlated with complexity. An RPG may have 80,000 downloads. Its score for feature A may be represented by 80,000/100,000, resulting in, for example, a complexity of 0.80. Similarly, if the download number for the RPG is 200,000, feature A may be represented by a score of 200,000, resulting in a complexity of 2. There may be a limit, however, to the extent that the number of downloads is associated with complexity. The classifier may establish an upper limit to the complexity score. Multiple complexity scores may be determined for a single application. For example, Feature B may be an average length of gameplay. The average length of gameplay for RPGs may be four minutes. The score for feature B may be computed similarly to that of feature A, with the average length of gameplay for a particular RPG divided by the classifier's determined average length of gameplay. A particular RPG, therefore, may have values of 0.80, 0.90, and 1.2 for features A, B, and C of the RPG classifier. The sum of those scores may represent the relative complexity score for the particular RPG.

A complexity score may be normalized across categories by computing the score for a specific application divided by the maximum score for the category of application. Continuing the above example, the RPG classifier with three features may have a maximum score of ten. A specific RPG application may have a score of eight. An email classifier may utilize five features and have a maximum score of twenty. A specific email application may have a score of ten. The specific RPG may have its relative score represented as 8/10=0.80 and the specific email application may have its relative score represented as 10/20=0.50. The relative scores may be multiplied by another value to provide a scaled value. Other methods of normalizing a score between categories of applications may be used.

The complexity score for an application may be displayed by the application store whenever a client device accesses the application's page on the application store. In some configurations, the application store may utilize the complexity score as a component of an application recommendation system. For example, a client device may conduct a query for a top 10 list of RPG games and the system may determine, based on the user associated with the client device, a similarity matching for the query, and the complexity score, which applications to suggest to the end user. Similarly, a user may conduct a query for a specific game and the search results returned to the user may be based on games matching the query as well as other games that are of similar complexity, and having other features (e.g., high download and/or retention rate, high user rating, positive sentiment, etc.).

A composite score for each application may be generated in response to a user's query and the various components that make up the composite score may be weighted. For example, a similarity/identity matching may be weighted higher than a normalized download number. As a non-limiting example, the components of a recommendation by the application store may be based on a combination of a query similarity/identity match, complexity score, user rating, and a normalized download number (e.g., the number of downloads divided by the average number of downloads for members of the same category). A composite score for application A may have values of 1.0 (indicating exact match), 0.9, 0.56, and 0.5, respectively, resulting in a composite score of 2.96. A composite score for application B may have values of 0.9, 0.7, 0.8, 0.75, respectively, resulting in a composite score of 3.15. Application B, therefore, may be ranked higher in the results of the query returned to the client device in response to the query. If other applications have higher composite scores than application A, application A may not be shown to the end user. As stated above, the components of the composite score may be weighted to increase/decrease the influence of a particular factor. The weighting may be customized based on the user. For example, a particular user may have a demonstrated affinity for very complex games (e.g., the user has lots of highly complex games, is in demographic for which complex games tend to be favored, has browsed many complex games, etc.), in which case, the complexity score may be multiplied by 1.0 to maintain its importance. Similarly, certain games below a threshold value of complexity may be excluded from the results of the query unless they are above a threshold level of similarity/match (e.g., the title of the application matches exactly the query terms). If a different user has a low affinity for complex games, games with high complexity scores may be excluded from the query results shown to the user. A user who demonstrates no particular affinity to complexity may have the influence of complexity on the composite score reduced by multiplying the complexity score by 0.5, for example.

As stated above, the complexity score may be different depending on an expertise level of a user. The system may determine a user expertise level based on one or more of demographic information for the user and a success ratio for the user, for example. Demographic information may include age, gender, location, etc. A recommendation may be based on the user's determined expertise level. As an example, a success ration may refer to the amount of time necessary to complete a task, mission, objection, level, game, etc. divided by the total amount of time spent playing a game. In some implementations, a classifier may be trained based on a category of application. The category of application may be provided by the developer or assigned by the application store. The classifier may be further stratified based on an expertise level or a type of user (e.g., demographic information) and/or the success ratio. Thus, the application store may contain multiple classifiers for various application categories and, in some instances, more specific classifiers for types of users within the defined categories.

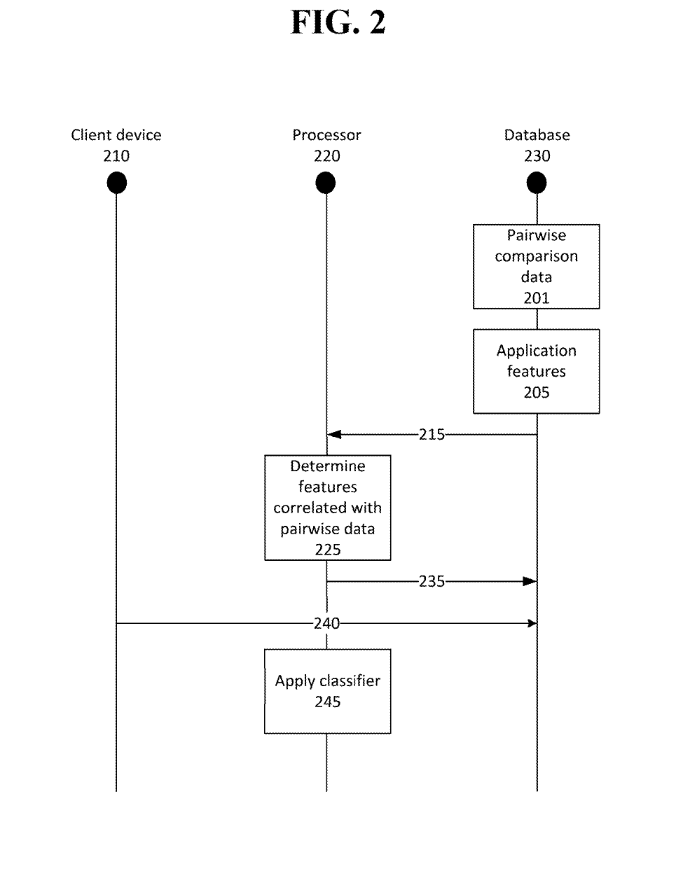

In an implementation, a system is disclosed that includes a database and a processor as shown in FIG. 2. The database 230 and processor 220 may be communicatively linked and components of an application store server. In some implementations, a classifier may be determined by a processor that is separate from the application store server and the resulting classifier may be provided to the application store server. The database 230 may store representations of the applications as features 205. As stated above, images, videos, comments, ratings, metadata, etc. that are uploaded and/or hosted by the application store as well as data obtained from external sources (e.g., external rating, external comments, external images, external videos, etc.) may be represented for each application. For example, a texture density analysis for images associated with an application may be determined and stored as part of a feature vector representing an application (among other features as described above). In some instances, source material may be stratified based on the version of the application to avoid obtaining a classifier based on an outdated version of an application.

The database 230 may store pairwise comparisons of relative complexity 201 for applications hosted by an application store. The pairwise comparisons may be generated as described earlier or obtained from a human rater. The processor 220 may receive into short-term memory the pairwise comparisons of relative complexity 201 and the features for the application 205 that are stored in the database. The processor 220 may receive an indication of which applications and corresponding feature and pairwise data are to be utilized for training the classifier as described above. The processor 220 may train a classifier by determining features that are correlated the pairwise comparison of relative complexity for the applications 225. The features correlated with the pairwise comparison data in the training set may define a classifier. As stated above, the classifier may be refined based on a category of applications (e.g., an email application, a RPG, a word game, a utility application, etc.). The classifier may be stored to the database 230.

In some configurations, a client device 210 may belong to a developer who uploads a new application to the database 230 at 240. The processor 220 may apply the classifier for the indicated category of the application 245. As above, the client device 210 in some instances may be used to access an application store for information about a particular application. The application store may provide an indication of the complexity store for the application. Similarly, the application store may generate a recommendation or respond to a query utilizing the complexity score.

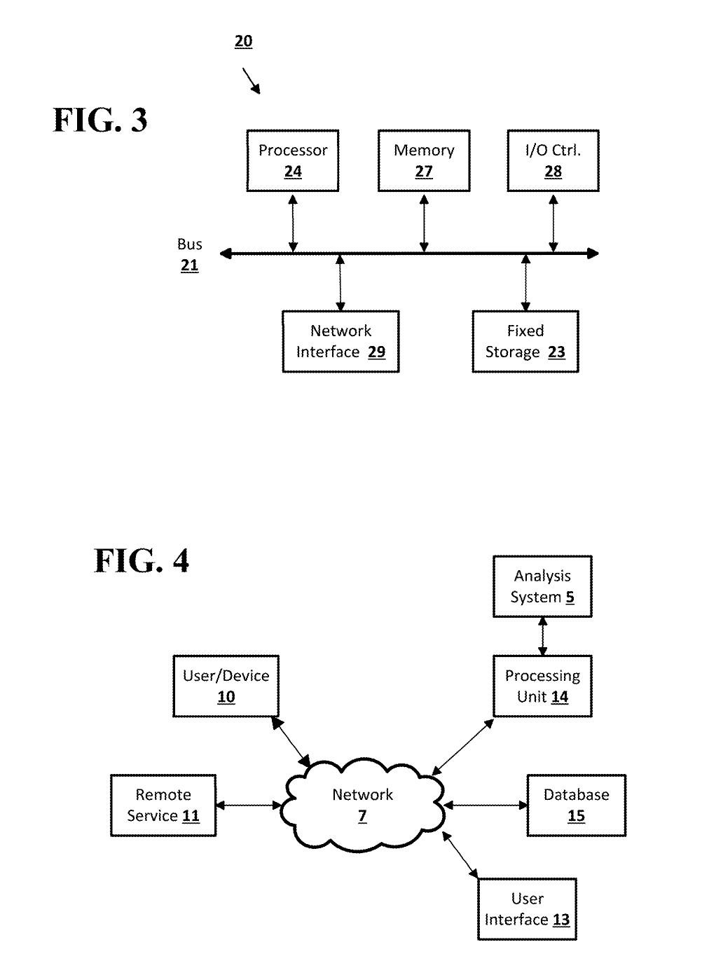

Embodiments of the presently disclosed subject matter may be implemented in and used with a variety of component and network architectures. FIG. 3 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 4.

Many other devices or components (not shown) may be connected in a similar manner, such as document scanners, digital cameras, auxiliary, supplemental, or backup systems, or the like. Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 4 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's provided input, a user's geographic location, and any other similar data associated with a user), or to control whether and/or how to receive data from a provider that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by systems disclosed herein.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
receiving, by a processor, a plurality of pairwise comparisons of relative complexity for each one of a plurality of applications as compared to an other of the plurality of applications, wherein the plurality of applications are hosted on an application store server;
obtaining a plurality of features for the plurality of applications, wherein the plurality of features comprises at least one of: a visual density of an image, a frequency of scene changes in a video, an average length of failed gameplay, a rating, a download number, and a sentiment metric; and
obtaining a classifier by determining, by the processor, a feature set comprising a portion of the plurality of features that correspond to a plurality of features that are correlated with the pairwise comparison of relative complexity for the plurality of applications.

2. The method of claim 1, further comprising selecting the plurality of applications based on an application category.

3. The method of claim 1, further comprising:
receiving a new application from a client device;
applying the classifier to a plurality of images for the new application; and
generating a complexity score for the new application.

4. The method of claim 3, further comprising presenting the complexity score to a second client device connected to the application store.

5. The method of claim 3, further comprising:
receiving, by the application store, a query from a second client device associated with a user; and
responsive to the query, generating a recommendation based on the query, the user of the second client device, and the complexity score.

6. The method of claim 5, further comprising determining a user expertise level based on at least one of: demographic information for the user and a success ratio for the user, wherein the recommendation is further based on the user expertise level.

7. The method of claim 1, wherein one of the portion of the plurality of features comprises a user expertise level that is based on at least one of demographic information for a plurality of users and a success ratio for the plurality of users.

8. The method of claim 1, wherein obtaining the classifier comprises training the classifier on a portion of the plurality of applications, wherein the portion of the plurality of applications are complex based on the pairwise comparisons of relative complexity.

9. A system, comprising:
a database for storing a plurality of pairwise comparisons of relative complexity for each one of a plurality of applications as compared to an other of the plurality of applications, wherein the plurality of applications are hosted by an application store server;
a processor communicatively coupled to the database, the processor configured to:
receive the plurality of pairwise comparisons of relative complexity;
obtain a plurality of features for the plurality of applications, wherein the plurality of features comprises at least one of: a visual density of an image, a frequency of scene changes in a video, an average length of failed gameplay, a rating, a download number, and a sentiment metric; and
obtain a classifier by determining a feature set comprising a portion of the plurality of features that correspond to a plurality of features that are correlated with the pairwise comparison of relative complexity for the plurality of applications.

10. The system of claim 9, the processor further configured to select the plurality of applications based on an application category.

11. The system of claim 9, the processor further configured to:
receive a new application from a client device;
apply the classifier to a plurality of images for the new application; and
generate a complexity score for the new application.

12. The system of claim 11, the processor further configured to present the complexity score to a second client device connected to the application store.

13. The system of claim 11, the processor further configured to:
receive, by the application store, a query from a second client device associated with a user; and
responsive to the query, generate a recommendation based on the query, the user of the second client device, and the complexity score.

14. The system of claim 13, further comprising determining a user expertise level based on at least one of: demographic information for a user and a success ratio for the user, wherein the recommendation is further based on the user expertise level.

15. The system of claim 9, wherein one of the portion of the plurality of features comprises a user expertise level that is based on at least one of demographic information for a plurality of users and a success ratio for the plurality of users.

16. The system of claim 9, wherein obtaining the classifier comprises training the classifier on a portion of the plurality of applications, wherein the portion of the plurality of applications are complex based on the pairwise comparisons of relative complexity.
